(19) United States
(12) Patent Application Publication
(10) Pub. No.: US 2003/0087129 A1
(43) Pub. Date: May 8, 2003

(54) Treated phosphor, making method, thin film making apparatus, and EL device

(75) Inventors: Noboru Miura, Tokyo (JP); Mitsuhiro Kawanishi, Kawasaki-shi (JP); Yoshihiko Yano, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corp., Tokyo (JP)

(21) Appl. No.: 10/307,319

(22) Filed: Dec. 2, 2002

Related U.S. Application Data
(62) Division of application No. 09/708,678, filed on Nov. 9, 2000, now abandoned.

(30) Foreign Application Priority Data
Apr. 14, 2000 (JP) 2000-113671

(51) Int. Cl. H05B 33/14; C09K 11/08

(52) U.S. Cl. 428/690; 428/917; 313/503; 252/301.4 S; 252/301.4 R; 427/66; 427/596

(57) ABSTRACT

A light-emitting thin film or phosphor is low temperature annealed by electron beam irradiation to effect crystallization and increase luminance without causing heat-associated damage to the underlying substrate. The treated thin film or phosphor is particularly well adapted for use in electroluminescent devices. The invention is also directed at a method and apparatus for reliably forming luminescent thin films endowed with such properties.

The present invention relates to a method of producing phosphors for use in light-emitting devices such as electroluminescent devices, plasma displays and vacuum fluorescent displays. More specifically, the invention relates to phosphors of greatly increased luminance achieved by electron beam annealing treatment, and a method of producing such treated phosphors. The invention is also directed at a thin-film manufacturing apparatus and electroluminescent devices.

### BACKGROUND OF THE INVENTION

Phosphors that have been developed for use in plasma displays and vacuum fluorescent displays include the blue-green light-emitting phosphor ZnO:Zn in which the host material is ZnO and the emission centers are zinc, the blue-emitting phosphors ZnS:Ag and ZnS:Cu, and the red-emitting phosphor (ZnCd)S:Ag+In₂O₃. Other phosphor materials are also under investigation.

Such blue-green phosphors luminesce brightly at relatively low voltages, and are already being put to practical use in vacuum fluorescent displays and plasma displays. However, the above blue-emitting and red-emitting phosphors do not have a sufficiently high luminance. Hence, there exists a need for blue-emitting and red-emitting low-power phosphors which have a high color purity.

Recently, thin-film electroluminescent (EL) devices have been the subject of active research efforts targeted at their use in small- and large-size lightweight flat panel displays. Monochrome thin-film EL displays which use phosphor thin films made of yellow-orange light-emitting manganese-doped zinc sulfide have been commercially developed with a double-insulated construction that employs, as shown in FIG. 2, thin-film insulating layers 2 and 4. In FIG. 2, a patterned bottom electrode 5 is formed on a glass substrate 1. A dielectric thin film is formed as a first insulating layer 2 over the bottom electrode 5. The first insulating layer 2 has formed thereon, in order, a light-emitting layer 3 and a second insulating layer 4 (dielectric thin film). A top electrode 6 is formed in a predetermined pattern on the second insulating layer 4 so as constitute, together with the bottom electrode 5, a matrix circuit. To enhance its luminance, the phosphor thin film is generally annealed at a temperature below the strain point of the glass substrate.

In one variation of the above structure that has recently been proposed, the substrate 1 is ceramic and the insulating layer 2 is a thick-film dielectric layer. The use of a ceramic such as alumina as the substrate enables the phosphor thin film to be annealed at a high temperature, making it possible for the phosphor to achieve a higher luminance. In addition, using a thick-film dielectric layer as the insulating layer enables a panel to be obtained which has greater resistance to dielectric breakdown and thus better reliability than an EL device in which thin films are used as the insulating layers.

Displays intended for use in personal computers, televisions and other viewing applications must have color capabilities. Thin-film EL displays using sulfide phosphor thin films have outstanding reliability and environmental resistance, but are not yet suitable as color displays owing to the inadequacy of EL phosphors which emit light in the three primary colors red, green and blue (RGB). Blue light-emitting phosphors currently under investigation for possible use in EL displays include SrS:Ce, in which the host material is SrS and the emission centers are cerium, and also SrGa₂S₄:Ce and ZnS:Tm. Other phosphors being studied for the same purpose include the red light-emitting phosphors ZnS:Sm and CaS:Eu, and the green light emitting phosphors ZnS:Tb and CaS:Ce.

These phosphor thin films which emit light in the three primary colors RGB lack sufficient brightness, luminous efficiency and color purity, and so are not ready at present for use in color EL panels. With regard to blue light in particular, although relatively high luminance has been achieved using a SrS:Ce phosphor, the color purity when this phosphor is utilized as the blue in a full-color display shifts somewhat toward the green side. Hence, a better blue light-emitting layer needs to be developed.

Efforts are currently underway to overcome the problems described above by developing thiogallate and thioaluminate blue light-emitting phosphors of excellent color purity, such as SrGa₂S₄:Ce, CaGa₂S₄:Ce and BaAl₂S₄:Eu (see, for example, JP-A 7-122364; JP-A 8-134440; Shingaku Giho EID 98-113, pp. 19-24; and Jpn. J. Appl. Phys. 38, L1291-1292 (1999)).

These strontium sulfide, thioaluminate and other phosphors are generally heat-annealed at a high temperature to induce crystallization and thus improve their luminance. Annealing is typically carried out by setting the substrate temperature during thin film formation to at least 600° C., or to 900° C. after thin film formation. Annealing with heat is carried out also on other phosphors such as zinc sulfide phosphors to improve crystallinity, extend the life of the phosphor and enhance reliability.

Heat annealing to improve luminance and reliability requires that the materials making up the underlying substrate, electrode, insulator and the like on which the phosphor is formed be heat-resistant. In the above-described prior-art EL devices comprising in part a glass substrate and thin-film insulating layers, the glass substrate has a heat resistance of at most about 500° C., making it impossible to increase the heat annealing temperature above this level. The EL devices described above which comprise in part a ceramic substrate and a thick-film insulating layer do have considerable heat resistance on account of the use of a highly heat-resistant noble metal such as platinum as the electrode and the use of a ceramic such as alumina as the substrate, yet such EL devices are prohibitively expensive. Moreover, during high-temperature heat annealing at above 900° C., the heat causes mutual diffusion of the constituent elements in the various materials within the laminated substrate/electrode/insulating layer/phosphor construction of the EL device. As a result, either properties appropriate for use as EL devices have been impossible to attain, or the devices themselves have been impossible to manufacture.

A desire thus exists for a technique which improves the luminance of phosphors used in light-emitting devices such as EL devices, plasma displays and vacuum fluorescent displays, and also improves the luminance and reliability of the device without heat annealing.

### SUMMARY OF THE INVENTION

It is therefore an object of the present invention to provide a thin film or phosphor which has a high luminance and excellent reliability. Another object of the invention is to provide a thin film or phosphor in which the luminance and reliability have been improved by treating the phosphor without resorting to a heating means such as a heater, and thus is free of heat-associated damage to the underlying structure on which the thin film or phosphor has been formed. An additional object of the invention is to provide a method of producing such phosphors. A further object of the invention is to provide a thin film manufacturing apparatus. A still further object is to provide an electroluminescent device.

In one aspect, the invention provides a phosphor which has been electron beam-irradiated to effect crystallization and increase luminance, the phosphor being referred to as “treated phosphor.” Typically, the phosphor is composed primarily of a sulfide, selenide or oxide, and preferably an alkaline earth sulfide. Preferred sulfides include alkaline earth thioaluminates, alkaline earth thiogallates, alkaline earth thioindates, zinc sulfide, strontium sulfide, calcium sulfide and magnesium zinc sulfide.

In another aspect, the invention provides an electroluminescent device comprising the foregoing treated phosphor, and preferably comprising also a substrate having a heat resistance temperature of up to 600° C.

In yet another aspect, the invention provides a method of producing a treated phosphor, which method comprises forming a phosphor and irradiating the phosphor with an electron beam to enhance its luminance. Preferably, the phosphor is formed as a thin-film layer, and the electron beam is scanned over the phosphor. The phosphor is typically electron beam irradiated from one side thereof, and irradiation is accompanied by simultaneous cooling from the side opposite to that being irradiated. The phosphor may be spun or translated at the time of electron beam irradiation. The phosphor is preferably electron beam irradiated during formation. Electron beam irradiation of the phosphor layer is typically carried out within a vacuum chamber into which hydrogen sulfide gas is introduced. It is preferable for luminescence from the electron beam-irradiated phosphor to be monitored, and for at least one parameter selected from the group consisting of the electron beam intensity, the relative positions of the electron beam and the phosphor, and the phosphor temperature to be controlled.

According to a further aspect, the invention provides a method of manufacturing a thin film, the method being comprised of forming a thin film in a vacuum and irradiating the thin film with an electron beam during film formation.

According to a yet further aspect, the invention provides a thin film manufacturing apparatus comprising (a) a vacuum chamber and, situated within the vacuum chamber, at least (b) an evaporation source for evaporating a thin film starting material, (c) a substrate on one side of which the thin film starting material that has evaporated from the evaporation source deposits to form a thin film, and (d) an electron beam source which irradiates with an electron beam the thin film that has formed on the substrate. The apparatus of the invention typically comprises also means for monitoring luminescence from the thin film, and means for heating or cooling the substrate from the side opposite to that irradiated by the electron beam.

The electron beam-annealed phosphors of the present invention were discovered in the course of experiments in which phosphors were electron beam-irradiated under a variety of conditions. Such inventive phosphors show vastly improved light emission characteristics compared with phosphors annealed by prior-art heating means such as a heater. Specifically, treatment of phosphors by electron beam irradiation has rendered them crystalline, increasing their luminance.

### BRIEF DESCRIPTION OF THE DRAWINGS

The objects, features and advantages of the invention will become more apparent from the detailed description given below, taken in conjunction with the accompanying drawings.

FIG. 1 is a schematic sectional view showing an apparatus which can be used to carry out the method of the invention, the apparatus being also one embodiment of the thin film-forming apparatus of the invention.

FIG. 2 is a fragmentary sectional view showing the construction of an inorganic electroluminescent device which can be manufactured using a phosphor thin film and an apparatus according to embodiments of different aspects of the invention.

FIG. 3 is a graph of the luminance versus voltage characteristics for the phosphor thin-film produced in Example 1 according to the invention.

FIG. 4 is a graph of the luminance versus voltage characteristics for the phosphor thin-film produced in Example 1 as a comparative sample.

FIG. 5 shows the x-ray diffraction pattern, before annealing, of the phosphor thin-film formed in Example 4.

FIG. 6 shows the x-ray diffraction pattern, after annealing, of the phosphor thin-film formed in Example 4.

### DETAILED DESCRIPTION OF THE INVENTION

The phosphor used in the invention may be any substance capable of emitting light, but a phosphor that can be used in EL devices, plasma displays and vacuum fluorescent displays is preferred. A phosphor suitable for use in a light emitting layer of an inorganic electroluminescent device is especially preferred because, given that the phosphor layer is formed on an underlying material having a substrate/electrode/insulating film construction, electron beam irradiation during or after formation of the phosphor film enables the phosphor layer to be crystallized in a short time without damaging the underlying material and provides a high-luminance phosphor.

The substrate and other components of the underlying material in this case do not need to have the high heat resistance normally required to endure heat annealing. Accordingly, when the phosphor is used in an inorganic EL device, the substrate may be composed of a glass having a relatively low heat temperature resistance, or may even be an organic substrate composed of a plastic such as polyimide. The substrate may thus be inexpensive and of large surface area, and the treatment time can be substantially shortened compared with heat annealing as used in the prior art. A substrate of this type is ideal for panel applications. For the purposes of the present invention, the heat resistance temperature of the substrate serving as the underlying material is preferably not more than 600° C., more preferably not more than 300° C., and most preferably not more than 150° C.

The phosphor is not subject to any particular limitation, although a material composed primarily of a sulfide, selenide, oxide, fluoride or nitride is preferred. Of these, a sulfide, selenide or oxide is more preferred, and a sulfide is most preferred.

Sulfides apparently undergo a striking improvement in emission characteristics when subjected to conventional heat annealing. The use of a sulfide phosphor is highly effective and thus advantageous in the present invention as well. Especially preferred sulfides include alkaline earth sulfides such as alkaline earth thioaluminates (RₓAl_{y}S_{z}, wherein R is beryllium, magnesium, calcium, strontium, barium or radium; and x, y and z are each independently positive integers), alkaline earth thiogallates (RₓGa_{y}S_{z}, wherein R is beryllium, magnesium, calcium, strontium, barium or radium; and x, y and z are each independently positive integers) and alkaline earth thioindates (RₓIn_{y}S_{z}, wherein R is beryllium, magnesium, calcium, strontium, barium or radium; and x, y and z are each independently positive integers); and zinc sulfide (ZnS), strontium sulfide (SrS), calcium sulfide (CaS) and magnesium zinc sulfide (ZnMgS). These sulfides need not be of exactly stoichiometric composition. The foregoing sulfides, when subjected to electron beam irradiation treatment, crystallize and undergo an increase in luminance. Crystals of such sulfides may be either of a single type or mixed crystals.

Of these, alkaline earth sulfides are preferred. In particular, ternary compounds such as alkaline earth thioaluminates, alkaline earth thiogallates and alkaline earth thioindates generally have a higher crystallization temperature than binary compounds such as ZnS and SrS. Such compounds are effective and thus preferred because they readily crystallize when subjected to electron beam irradiation according to the invention. Of the ternary sulfur compounds that may be used, BaAl₂S₄ lends itself especially well to use in the invention because it is difficult to crystallize by conventional heat annealing. Ternary compounds such as alkaline earth thioaluminates, alkaline earth thiogallates and alkaline earth thioindates, represented generically as AₓB_{y}S_{z}, may have any of the following formulas: AB₂S₄, AB₄S₇, A₂B₂S₅, A₄B₂S₇ or A₅B₂S₅.

No particular limitation is imposed on selenides that may be used. Preferred examples include alkaline earth selenoaluminates (RₓAl_{y}Se_{z}, wherein R is beryllium, magnesium, calcium, strontium, barium or radium; and x, y and z are each independently positive integers), alkaline earth selenogallates (RₓGa_{y}Se_{z}, wherein R is beryllium, magnesium, calcium, strontium, barium or radium; and x, y and z are each independently positive integers), and alkaline earth selenoindates (RₓIn_{y}Se_{z}, wherein R is beryllium, magnesium, calcium, strontium, barium or radium; and x, y and z are each independently positive integers).

The method of manufacture according to the invention is effective not only for producing phosphors, but also for preparing crystalline thin films from amorphous thin films. Such thin films are generally formed by a vapor phase deposition process Involving film formation in a vacuum, such as vacuum evaporation or sputtering. Thin films of this type may also be used to form insulating layers in EL devices.

To treat the phosphor layer without damaging the underlying material, the electron beam used in the invention preferably has an acceleration voltage within a range of 1 to 20 kV, and especially 4 to 6 kV; an emission current within a range of 0.1 to 1 mA, and especially 1 to 10 mA; and an irradiation time within a range of 10 seconds to 5 minutes, and especially 2 to 4 minutes. Irradiation conditions above these respective ranges tend to result in damage to the underlying material, whereas irradiation conditions below these ranges generally fail to provide the desired effects.

The thickness of the phosphor layer is not subject to any particular limitation, although a thicker layer will require a higher electron beam intensity or a longer irradiation time. Conversely, a lower electron beam intensity or shorter irradiation time will suffice for treating a thinner phosphor layer. The optimal film thickness varies also with the type of luminescent material, although a thickness of 100 to 2,000 nm is preferred, and a thickness of about 150 to 700 nm is especially preferred. The electron beam irradiation conditions will vary with the film thickness and must be set in such a way as to minimize damage to the material underlying the phosphor and other undesirable effects.

In the manufacturing method of the invention, it is preferable to irradiate a thin-film layer, particularly a phosphor layer, having a thickness of 50 nm to 2 μm by scanning an electron beam over the layer. Scanning enables a large surface area to be treated and makes it possible to prevent localized heating by the electron beam and consequent damage to the underlying material.

To keep from damaging the underlying material during electron beam irradiation, it is advantageous to simultaneously cool the substrate from the side opposite to the side being irradiated. This may be done by bringing the thin-film layer or phosphor layer into contact with a substrate holder, and cooling the holder with a cooling medium such as water, liquid nitrogen or Freon.

To treat a large surface area, such as that on a panel, if necessary, the thin film or phosphor may be spun or translated during electron beam irradiation. Translation or spinning of the thin film or phosphor ensures uniform treatment over the face thereof, reducing the variability in luminance over the film surface. If the substrate is spun, the spin rate is preferably at least about 10 rpm, more preferably about 10 to 50 rpm, and most preferably about 10 to 30 rpm. An excessive spin rate tends to result in poor sealability when the substrate is placed in the vacuum chamber. On the other hand, a spin rate which is too low may allow the underlying material to be damaged during treatment, reducing the brightness characteristics of the manufactured phosphor. The means for spinning the substrate may be a known spinning mechanism comprising a power source such as a motor or rotary hydraulic mechanism in combination with a power transfer mechanism or speed reduction mechanism which employs gears, belts or pulleys. When used in combination with electron beam scanning, spinning enables the face of the panel to be uniformly treated, making it possible to achieve uniform properties over a larger surface area.

In the method of the invention, the electron beam-irradiated side of the thin-film layer or phosphor layer in the film thickness direction receives the most treatment. Depending on the electron beam irradiation conditions, a treatment profile may arise across the film thickness. In such cases, it is advantageous to carry out electron beam irradiation treatment during formation of the thin film in a vacuum, such as by applying the electron beam to the phosphor while the phosphor layer is being formed. “Vacuum,” as used herein, refers to a degree of vacuum within a range that permits electron beam irradiation, and generally a degree of vacuum represented by a pressure of 0.133 Pa (1×10⁻³ torr) or less. The phosphor layer can be completely treated in this way using a low-energy electron beam, without the formation of any treatment profile in the film thickness direction. Because the energy of the electron beam is applied at the same time as the energy of the atoms, molecules or clusters that fly from the evaporation source to the substrate during formation of the phosphor layer by a vacuum film forming process, a highly crystalline phosphor layer can be obtained. If there is not enough energy for crystallization to take place, the phosphor layer may be heated, such as by bringing the phosphor layer to be treated into contact with a substrate holder, and heating the holder with a heater. The extra heating temperature is preferably not more than 50%, and especially not more than 25% of the temperature required for heat annealing.

Electron beam irradiation in a vacuum may cause sulfur to evaporate from the surface of a sulfide phosphor layer, leading to the formation of sulfur defects on the phosphor. In such cases, it is advantageous to introduce hydrogen sulfide gas into the vacuum chamber. The amount of hydrogen sulfide gas introduced varies according to the performance of the vacuum system, although an amount of 1 to 200 SCCM, and especially 5 to 30 SCCM, is preferred. The hydrogen sulfide is preferably introduced in such a way as to bring the pressure inside the vacuum chamber within a range of 1.33×10⁻² to 13.3 Pa (1×10⁻⁵ to 1×10⁻³ torr). A pressure within this range allows the electron gun that generates the electron beam to operate stably and enables a hydrogen sulfide effect to be obtained. The hydrogen sulfide gas introduced into the vacuum chamber supplements sulfur that may be lost due to evaporation, ensuring that a low-defect, highly crystalline sulfide phosphor is obtained.

Cathodoluminescence (CL) from the irradiated surface of the thin film or phosphor can generally be observed during electron beam treatment. Such cathodoluminescence generally corresponds to the luminance of the thin film or phosphor. For example, the greater the intensity of CL observed during treatment in the production of an EL device, the higher the luminance, or brightness, of electroluminescence by the finished device. This fact makes it possible to use a CL monitor to set the electron beam irradiation conditions. For instance, if electron beam irradiation is being carried out, irradiation endpoint treatment to terminate irradiation can be carried out when a sufficient rise in CL intensity has occurred. Feedback control of the electron beam intensity, scan rate, substrate spinning or translation conditions, and substrate temperature based on the monitored CL intensity is advantageous because it can be used to carry out optimal electron beam treatment, making it possible to set conditions which enhance the emission characteristics of the phosphor.

The monitoring means used to observe cathodoluminescence is not subject to any particular limitation, provided it has a light-detecting capability. Illustrative examples include semiconductor devices capable of photoelectric conversion, such as phototransistors, photodiodes and charge coupling devices (CCDs). Of these, CCDs are preferred because of their capabilities, ease of use and relatively low cost. Typically, CL signals which have been converted to electrical signals by the photoelectric conversion device are analog-to-digital converted and input to a computer, where they are analyzed by a software program, based upon which feedback to the electron beam intensity, scan rate, substrate spinning or translation conditions, and substrate temperature is carried out. Alternatively, control may be carried out using a dedicated processor, control circuits or other appropriate equipment.

When a large surface area is treated by such operations as electron beam scanning and substrate spinning or translation, cathodoluminescence at each of the electron beam irradiation sites on the phosphor may be monitored to control electron beam irradiation in such a way as to achieve uniform CL intensity over the entire surface. Such an approach makes it possible to produce a light-emitting layer which is uniform over the entire surface of the panel, enabling a finished panel of uniform luminance to be obtained. If the panel application calls for light emission from only a portion of the panel face, a locally emissive surface can be achieved by electron beam irradiation treatment of only the desired area. Locally emissive surfaces can easily be manufactured in this way through the use of CL monitoring.

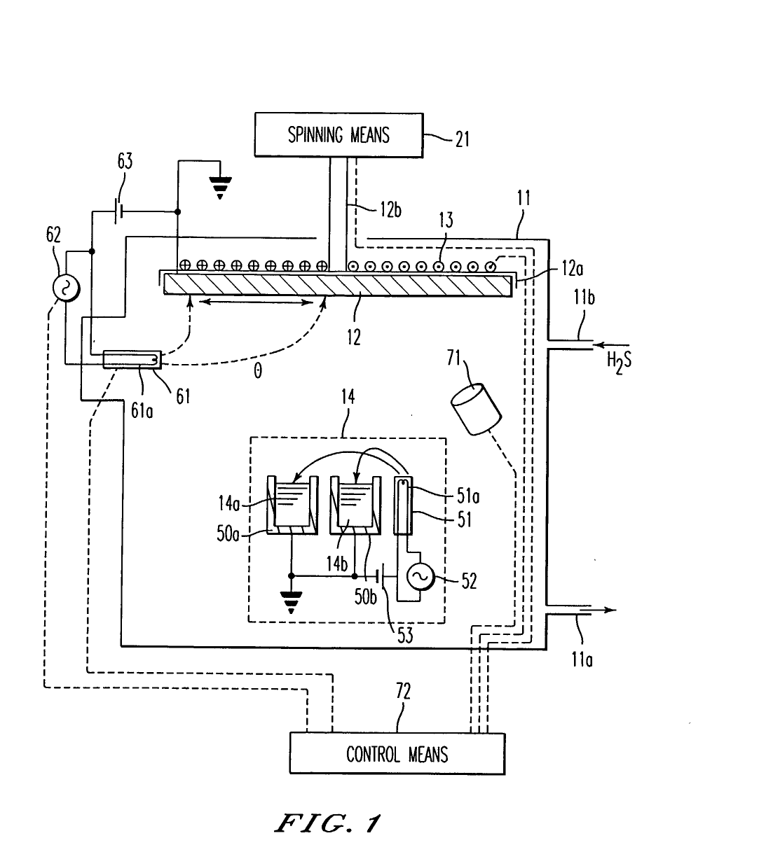

FIG. 1 shows an example of an apparatus that may be used to form the thin film or phosphor of the invention. In the discussion that follows, the thin film formed using this apparatus shall, for the purpose of illustration, be a BaAl₂S₄:Eu phosphor. In FIG. 1, a vacuum chamber 11 contains a substrate 12 on which a thin film of the phosphor is to be formed, and an electron beam evaporation source 14 comprising an evaporation source 14a composed of the thin film-forming material europium-doped barium sulfide and an evaporation source 14b composed of the thin film-forming material aluminum sulfide. The vacuum chamber 11 has an exhaust port 11a through which air can be discharged to set the interior of the chamber 11 at a predetermined degree of vacuum.

The substrate 12 is secured to a substrate holder 12a which is attached to a shaft 12b. The shaft 12b is mounted in a freely rotatable manner to a shaft mounting and spinning means 21 located outside the vacuum chamber 11, in such a way as to maintain the vacuum within the chamber 11. The shaft 12b can be spun as required at a predetermined speed by the spinning means 21. The substrate holder 12a has closely attached thereto heating or cooling means 13, typically comprising a heater or cooling lines through which passes a fluorocarbon coolant, capable of heating or cooling the substrate 12 so as to maintain it at a desired temperature.

The substrate 12 is irradiated by an electron beam e which is discharged from an electron gun 61 and scans over the surface of the substrate 12. The electron gun 61 contains an internal mechanism for controlling the beam e. The beam-controlling mechanism may be, for example, a deflection yoke which applies a predetermined magnetic field, or a deflecting plate which applies a predetermined electrical field across a pair of electrodes. The electron gun 61 is connected to an alternating current power source 62 and a bias power source 63.

The electron beam evaporation source 14, which serves as a means for evaporating the aluminum sulfide and barium sulfide, has crucibles 50a and 50b for holding emission center-doped barium sulfide 14a and aluminum sulfide 14b, and an electron gun 51 which contains an electron-emitting filament 51a. The electron gun 51 is connected to an alternating current power source 52 and a bias power source 53. The electron gun discharges an electron beam which is controlled so as to alternately evaporate, at a preset power, the emission center-doped barium sulfide and the aluminum sulfide in a predetermined ratio therebetween. According to Jpn. J. Appl. Phys. 38, L1291-1291 (1999), vacuum evaporation in which evaporation from multiple sources is carried out with a single electron gun is sometimes called “multiple-source pulse deposition.”

The vacuum chamber 11 also includes a photodetector 71 having a photoelectric conversion capability for detecting cathodoluminesconce emitted by the substrate. The photoelectric-converted CL signals are sent to a control means 72. According to one arrangement that may be used to work the invention, the control means 72 analyzes the input CL signals and adjusts the alternating current power source 62 output to the electron gun 61 so as to achieve the target CL luminance, or controls the electron beam e from the electron gun 61 so as to obtain a uniform CL luminance. According to another arrangement that may be used, the control means 72 controls the substrate 12 heating or cooling means 13 so as to achieve the desired annealing effect, or prevents overheating of underlying material such as the substrate 12. According to yet another arrangement, the control means 72 controls the spinning means 21 or a substrate translational means so as to carry out uniform annealing and achieve uniform cathodoluminescence, or sets the annealing conditions by suitable adjustment of the spin or translation conditions.

Using an apparatus as described above, the barium sulfide vapor and the aluminum sulfide vapor created at the electron beam evaporation source 14 are deposited on the substrate and chemically bonded to form a light-emitting layer. The substrate is concurrently cooled to a temperature of not higher than about 20° C. and is moreover irradiated by being scanned with the electron beam e from the electron gun 61, thereby forming a crystallized film. If necessary, the crystallinity and distribution in the emission properties of the deposited light-emitting layer can be made more uniform by spinning the substrate. Alternatively, the substrate 12 may be moved using a translational means such as an X-Y table instead of the spinning means 21.

The foregoing discussion describes the electron beam-treated phosphors according to the invention, and the inventive method of manufacture and manufacturing apparatus which can be used to easily form high-luminance phosphor thin-films. Any of these aspects of the invention can be effectively employed in such applications as EL full-color panels for electronic displays.

### EXAMPLE

The following examples are provided to illustrate the invention, and are not intended to limit the scope thereof.

### Example 1

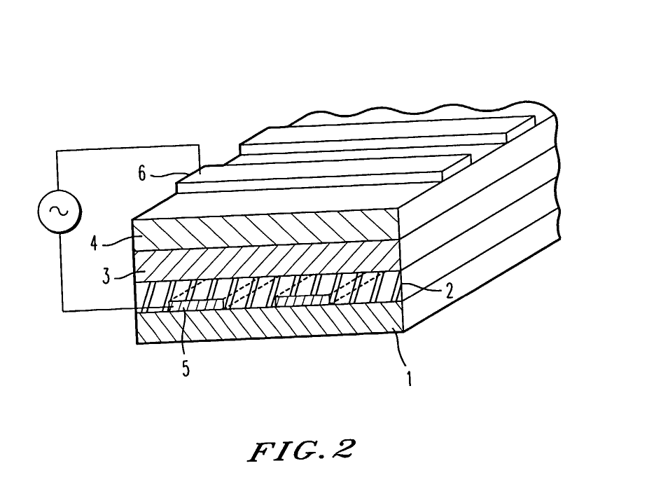

An EL device was manufactured using a phosphor according to the invention. The EL device had the structure shown in FIG. 2, which has already been described.

First, a 200 nm thick ITO layer was sputtered onto a glass substrate to form a bottom electrode layer. A 320 nm Ta₂O₅ film and a 270 nm ZnS film were then successively formed as a first insulating layer by vacuum evaporation. The resulting construction was annealed at 400° C. in a vacuum for 60 minutes to give the device substrate.

On the substrate, a 200 nm thick light-emitting layer of BaAl₂S₄ was formed thereon by pulse deposition. Electron beam pulses were regulated to set the composition of the phosphor formed on the substrate using 5 mol % europium-doped barium sulfide pellets and aluminum sulfide pellets as the evaporation sources to BaAl₂S₄. The phosphor was confirmed by x-ray diffraction analysis and other techniques to be amorphous at this point.

Electron beam irradiation according to the invention was then carried out. FIG. 1 shows an example of a vacuum evaporation apparatus which can be used in the manufacturing method of the invention. Although the apparatus shown in FIG. 1 can be used for vacuum evaporation, it was used in the present example only to carry out electron beam irradiation. Thin film formation was not carried out.

The substrate on which the BaAl₂S₄ phosphor had been formed was closely secured to an electron beam-irradiatable region (the area indicated by the arrows in the diagram) of the substrate holder 12a. The holder 12a was attached to the shaft 12b and irradiation was carried out without spinning. The temperature of the holder 12a was set at about 20° C.

The irradiation conditions were an electron gun acceleration voltage of 6 kV, an emission current of 5 mA, and scanning within a 3 cm square region at a frequency of 50 Hz In the x-direction and 500 Hz in the y-direction. Irradiation was stopped when CL mission at the irradiated surface reached a maximum value. The irradiation time was about 3 minutes. The phosphor crystallized, and a BaAl₂S₄ crystal peak was noted in the x-ray diffraction pattern.

A 180 nm ZnS film and a 320 nm Ta₂O₅ film were successively formed as a second insulating layer by vacuum evaporation on the resulting phosphor.

Finally, aluminum was electron beam vacuum-evaporated on the second insulating layer to form a 200 nm thick top electrode layer, thereby completing the EL device. The device was entirely free of electron beam irradiation damage such as glass substrate warpage and electrical shorting of the insulating layers.

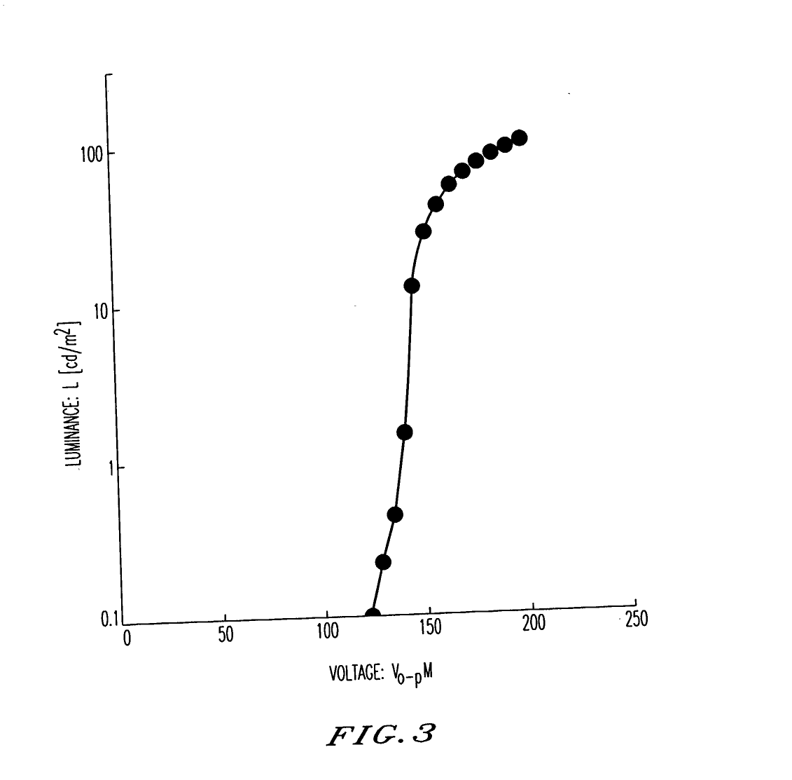

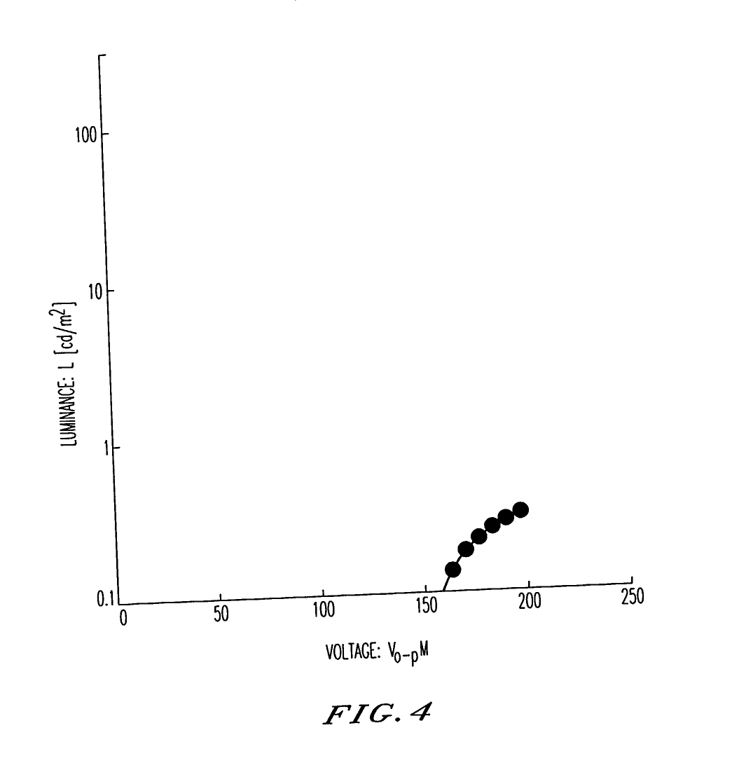

The emission characteristics of the resulting EL device were evaluated. A 60 Hz, 40 μS pulse width bipolar electrical field was applied across electrode leads from the ITO bottom electrode and the aluminum top electrode in the resulting EL construction. The luminance-voltage characteristics are shown in FIG. 3. As is apparent from this plot, a luminance of 100 cd/m₂ was obtained with good reproducibility. In a comparative example, an EL device manufactured under exactly the same conditions but without electron beam irradiation had a luminance of 0.3 cd/m², which was less than 1/300^{th} as large (see FIG. 4). This demonstrates that carrying out electron beam annealing according to the invention dramatically enhances the luminance. In another comparative example, an EL device otherwise produced under exactly the same conditions as in the original example according to the invention, but subjected to conventional heat annealing treatment at 900° C. instead of electron beam irradiation, had a luminance of 50 cd/m². The latter EL device had a warped glass substrate. Moreover, the luminance was no more than half that of the EL device according to the invention.

### Example 2

A BaAl₂S₄ phosphor was produced in the same way as in Example 1 using a vacuum evaporation apparatus of the type shown in FIG. 1 suitable for use in the manufacturing method of the invention. In this example, 10 SCCM of hydrogen sulfide gas was introduced into the vacuum chamber, and the pressure during vacuum evaporation was set at 1.33×10⁻² Pa (1×10⁻⁴ torr).

Electron beam irradiation was carried out concurrent with thin film formation. The irradiation conditions were as follows: substrate holder temperature, about 20° C.; electron gun acceleration voltage, 4 kV; emission current, 1 mA; scanning frequency in a 3 cm square region, 50 Hz in x-direction and 500 Hz in y-direction. Vacuum evaporation and electron beam irradiation were stopped when the phosphor film thickness reached 200 nm. The phosphor crystallized and a BaAl₂S₄ crystal peak was observed in the x-ray diffraction pattern.

Using the resulting light-emitting layer, an EL device was manufactured in the same way as in Example 1. A blue luminance of 120 cd/m² was obtained with good reproducibility when a 60 Hz, 40 μS pulse width electrical field was applied across the electrodes. In areas of the phosphor not electron beam irradiated, the luminance fell to at most 1/100^{th} the above value, demonstrating that locally emissive surfaces can be manufactured using electron beam irradiation.

### Example 3

A phosphor was produced in the same way as in Example 1. In the present example, a 4-inch large surface area substrate was used, the substrate was spun, and electron beam treatment was carried out. During treatment, local areas of low CL intensity were observed on the irradiated surface. The electron beam was thus controlled to increase the electron beam dose in the areas of low CL intensity, thereby resulting in a uniform CL intensity over the entire 4-inch surface. An evaluation of the electroluminescence on the 4-inch surface indicated good uniformity in the luminance with a variance of less than 10%. Another example was carried out for the sake of comparison in which the electron beam was not controlled and areas of low CL intensity were not given a higher electron beam dose. The variance in luminance in this case was 50%.

### Example 4

As in Example 1, a bottom electrode layer and a first insulating layer (the latter composed of a Ta₂O₅ film and a ZnS film in this order) were successively formed an a glass substrate, then annealed.

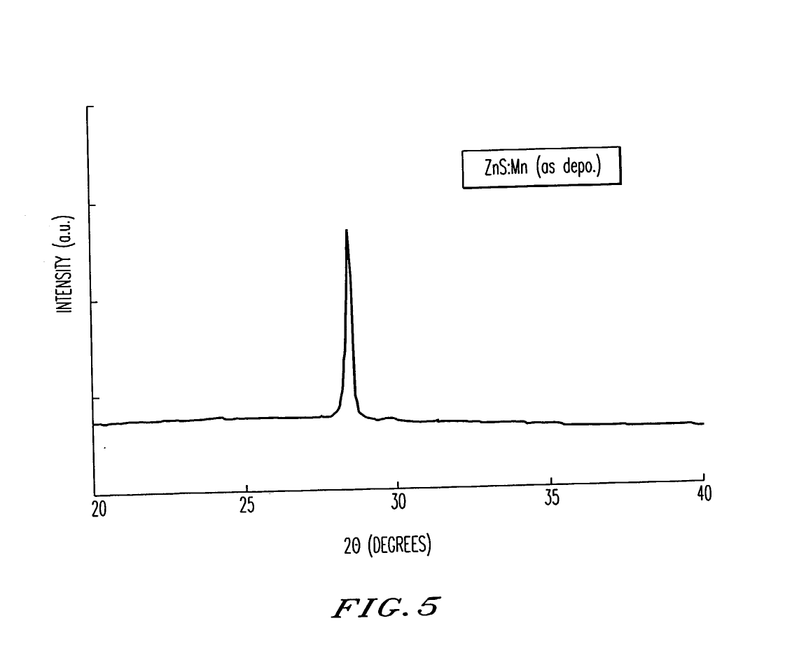

A 600 nm thick light-emitting layer of ZnS:Mn was then formed by vacuum evaporation on the resulting substrate using 0.5 mol % manganese-doped zinc sulfide pellets as the evaporation source. The x-ray diffraction pattern obtained for the deposited layer of ZnS:Mn at this point is shown in FIG. 5.

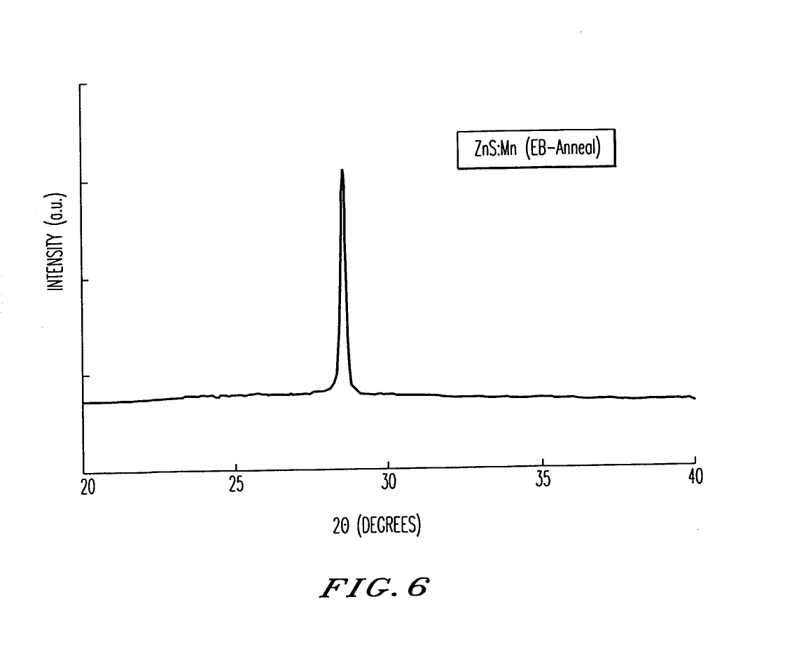

Next, electron beam irradiation was carried out in the same way as in Example 1. The irradiation conditions were as follows: electron gun acceleration voltage, 6 kV; emission current, 5 mA; scanning frequency in a 3 cm square region, 50 Hz in x-direction and 500 Hz in y-direction. The irradiated surface was observed, and irradiation was stopped when the cathodoluminescence reached a maximum. The irradiation time was about 3 minutes. The phosphor crystallized further during irradiation treatment. FIG. 6 shows the x-ray diffraction pattern for the electron beam-treated phosphor layer. It is apparent from FIG. 6 that the intensity at the ZnS crystal peak has increased relative to that in FIG. 5.

Next, a second insulating layer (composed of ZnS. then Ta₂O₅) was formed as in Example 1, following which aluminum was electron beam vacuum evaporated onto the second insulating layer to form a top electrode layer, thereby completing production of the EL device. The EL device thus obtained was entirely free of electron beam irradiation damage such as glass substrate warpage and electrical shorting of the insulating layers.

The emission characteristics of the EL device were evaluated in the same manner as in Example 1. A luminance of 4,000 cd/m² was obtained with good reproducibility when a 1 kHz, 50 μS pulse width bipolar electrical field was applied across the electrodes. In a comparative example, an EL device that was not electron beam irradiated but was otherwise manufactured under exactly the same conditions had a luminance of only 400 cd/m², or at most only one-tenth as large. This showed that electron beam annealing according to the invention dramatically enhances luminance.

### Example 5

A bottom electrode layer and an insulating layer (the latter composed of a Ta₂O₅ film and a ZnS film in this order) were successively formed on a glass substrate and annealed in the same manner as in Example 1.

Next, a light-emitting layer of CaGa₂S₄ was formed on the resulting substrate to a thickness of 500 nm by pulsed vapor deposition. Using as the evaporation sources 1 mol % cerium-doped CaS pellets and Ga₂S₃ pellets, the electron beam pulses were regulated so as to make the composition of the phosphor that formed on the substrate CaGa₂S₄. X-ray diffraction analysis and other techniques confirmed that the phosphor had not crystallized at this point.

Next, electron beam irradiation was carried out as in Example 1. The irradiation conditions were as follows: electron gun acceleration voltage, 6 kV; emission current, 5 mA; scanning frequency in a 3 cm square region, 50 Hz in x-direction and 500 Hz in y-direction. The irradiated surface was observed, and irradiation was stopped when the cathodoluminescence reached a maximum. The irradiation time was about 3 minutes. The x-ray diffraction pattern showed a CaGa₂S₄ crystal peak, indicating that the phosphor had crystallized.

Next, a second insulating layer (composed of ZnS, then Ta₂O₅) was formed as in Example 1, following which aluminum was electron beam vacuum deposited onto the second insulating layer to form a top electrode layer, thereby completing production of the EL device. The resulting EL device was entirely free of electron beam irradiation damage such as glass substrate warpage and electrical shorting of the insulating layers.

The emission characteristics of the EL device were evaluated in the same manner as in Example 1. A luminance of 20 cd/m² was obtained with good reproducibility when a 60 Hz, 40 μS pulse width bipolar electrical field was applied across the electrodes. In a comparative example, an EL device that was not electron beam irradiated but was otherwise manufactured under exactly the same conditions had a luminance of only 0.2 cd/m², or at most only 1/100th as large, demonstrating that electron beam annealing according to the invention dramatically enhances luminance.

The foregoing examples show that phosphors which have been electron beam annealed exhibit a dramatically improved luminance compared with phosphors which have been conventionally annealed using a heating means such as a heater.

Because the inventive phosphor enhances the luminance of the EL panel and makes it unnecessary to carry out an annealing step following thin film formation, it can help shorten the production time and reduce production costs. Moreover, by controlling the electron beam, a phosphor can be obtained which is uniform over a large surface area. Such an approach is thus ideally suited for the manufacture of EL panels and has considerable practical value.

As will have become apparent from the foregoing discussion and examples, the present invention provides thin films or phosphors having a high luminance and a high reliability. Moreover, by subjecting a thin film or phosphor to annealing treatment which does not rely on a heating means such as a heater, the invention provides also a thin film or phosphor in which the luminance and reliability have been enhanced without damaging the underlying structure on which the thin film or phosphor is formed. The invention further provides a method for producing such thin films or phosphors, a thin film producing apparatus, and an EL device.

Japanese Patent Application No. 2000-113671 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. A phosphor which has been electron beam-irradiated to effect crystallization and increase luminance.

2. The treated phosphor of claim 1, which is composed primarily of a sulfide, selenide or oxide.

3. The treated phosphor of claim 1, which to composed primarily of an alkaline earth sulfide.

4. The treated phosphor of claim 2, wherein the sulfide is selected from the group consisting of alkaline earth thioaluminates, alkaline earth thiogallates, alkaline earth thioindates, zinc sulfide, strontium sulfide, calcium sulfide and magnesium zinc sulfide.

5. An electroluminescent device comprising the treated phosphor of claim 1.

6. The electroluminescent device of claim 5, further comprising a substrate having a heat resistance temperature of up to 600° C.

7. A method of producing a treated phosphor, comprising the steps of forming a phosphor and irradiating the phosphor with an electron beam to increase its luminance.

8. The method of claim 7, wherein the phosphor is formed as a thin-film layer.

9. The method of claim 7, wherein the electron beam is scanned over the phosphor.

10. The method of claim 7, wherein the phosphor is electron beam irradiated from one side thereof, and irradiation is accompanied by simultaneous cooling from the side opposite to that being irradiated.

11. The method of claim 7, wherein the phosphor is spun or translated at the time of electron beam irradiation.

12. The method of claim 7, wherein the phosphor is irradiated with an electron beam during formation.

13. The method of claim 8, wherein the phosphor layer is irradiated with the electron beam within a vacuum chamber into which hydrogen sulfide gas is introduced.

14. The method of claim 7, wherein luminescence from the electron beam-irradiated phosphor is monitored, and at least one parameter selected from the group consisting of the electron beam intensity, the relative positions of the electron beam and the phosphor, and the phosphor temperature is controlled.

15. A method of manufacturing a thin film, comprising the steps of forming a thin film in a vacuum and irradiating the thin film with an electron beam during film formation.

16. A thin film manufacturing apparatus comprising:
(a) a vacuum chamber and, situated within the vacuum chamber, at least
(b) an evaporation source for evaporating a thin film starting material,
(c) a substrate on one side of which the thin film starting material that evaporates from the evaporation source deposits to form a thin film, and
(d) an electron beam source which irradiates with an electron beam the thin film that is formed on the substrate.

17. The apparatus of claim 16 which further comprises means for monitoring luminescence from the thin film.

18. The apparatus of claim 16 which further comprises means for heating or cooling the substrate from the side opposite to that irradiated by the electron beam.
